(19) United States
(12) Patent Application Publication
(10) Pub. No.: US 2014/0360483 A1
(43) Pub. Date: Dec. 11, 2014

(54) HEIGHT ADJUSTABLE FIRE PIT GRATE ASSEMBLY WHOLLY CARRIED BY A FIRE PIT RING

(71) Applicants: Gary W. Mattix, Kimberly (CA); Scott Richard Mattix, Kimberly (CA)

(72) Inventors: Gary W. Mattix, Kimberly (CA); Scott Richard Mattix, Kimberly (CA)

(21) Appl. No.: 13/912,367

(22) Filed: Jun. 7, 2013

(51) Int. Cl. A47J 33/00

(52) U.S. Cl. CPC A47J 33/00
USPC 126/30

(57) ABSTRACT

A grate assembly for use over a fire, surrounded by a cylindrical fire pit ring, comprising: a) an inverted U shaped clamp having an inner and an outer opposite side, a central portion extending between, and connecting the two opposite side portions, wherein the outer opposite side portion further comprises a centrally positioned screwed hole and a screw, to tighten the clamp on the fire pit ring, an end portion of the central portion also has a centrally positioned screwed hole and a screw, to level the clamp when it is seated on the cylindrical fire pit ring; b) an upwardly extending post attached to the clamp; and, c) a grate, surrounded by a frame, said frame attached to, a cylindrical tube, sized to closely fit over the post, and further comprising grate-post attachment means to clamp the grate to the post at a preferred height.

### FIELD OF THE INVENTION

This invention relates to fire pits, particularly in campgrounds, supplied with a heavy cylindrical fire pit ring. More particularly this invention relates to a height adjustable fire pit grate assembly which is quickly installed on, and removed from. a top portion of the cylindrical fire pit ring by which it is wholly supported.

### BACKGROUND OF THE INVENTION

The applicants are frequent campers in the numerous Provincial Parks in Canada. Generally, campsites in these government operated parks include a fire pit having a heavy cylindrical fire pit ring. These fire pits may include a wide spaced grate which is positioned on a top end portion of the heavy cylindrical fire pit ring. These cylindrical rings sometimes include a top rim. One problem with this arrangement is that the wide spaced grate, because of the misalignment of the cylindrical ring by which it is supported, is almost never horizontal. If the wide spaced grate is used to support a frying pan used to cook eggs, the eggs invariably slide to the lowest side corner portion of the frying pan where they cook in a lump. Another problem with using the supplied wide spaced grate is that it cannot be adjusted for height above the fire. Usually a fire must be lit In the morning before breakfast can be cooked. Initially the fire supplies minimal heat, then it supplies intense heat, before it finally burns to coals which then supply a uniform and steady, but a relatively lower quantity of heat. When using a fire to cook, it is desirable to have a grate which can be conveniently adjusted for height. When their is a bright flame, the grate is positioned higher above the flame. When there are coals, the grate is positioned at a lower level above the low, but steady heat generated by the burning coals.

There are fire pit grates available which comprise a stake or post which is driven into the ground. To use these a camper must carry a mallet. Sometimes the ground is rocky and it is difficult to drive the post sufficiently into the ground. The post must be driven deep enough in order to resist the twisting moment caused by a load on the grate, entirely on one side of the post. When the camping is over the post must be pulled from the ground. A more convenient grate assembly is needed. One that can be more conveniently installed, and one that can more easily be removed.

### OBJECTS OF THE INVENTION

It is an object of this invention to disclose a more convenient grate assembly. A grate assembly that doesn't have a post which needs to be deeply driven into the ground with a mallet. A grate assembly that can be easily removed without pulling a deeply embedded post from the ground. It is an object of this invention to disclose a grate assembly which is wholly carried by a fire pit ring, and which can be leveled to a horizontal position even when s top side of the fire pit ring is substantially deviated from a horizontal plane. It is yet a further object of this invention to disclose a fire pit grate assembly which can be installed. without the need for any tools, into a sturdy operable position, quickly, conveniently, and without any physical exertion.

One aspect of this invention provides for a height adjustable grate assembly for use over a fire, surrounded by a cylindrical fire pit ring, comprising: a) an inverted U shaped clamp having an inner and an outer opposite side, said opposite sides generally parallel to each other, and having a central portion extending between, and connecting the two opposite side portions, wherein the outer opposite side portion further comprises a centrally positioned screwed hole and a screw turned therein, to thereby tighten the clamp on the fire pit ring, and wherein an end portion of the central portion also has a centrally positioned screwed hole and a screw turned therein, to level the clamp when it is seated on the cylindrical fire pit ring if the ring thereunder is not level; b) a post attached to the clamp, extending upwardly therefrom; and, c) a grate, surrounded by a frame, said frame attached to, and carried by a cylindrical tube, sized to closely fit over the post, and further comprising grate-post attachment means to clamp the grate to the post at a preferred height. After the inverted U shaped clamp is seated on a top portion of the cylindrical fire pit ring, and leveled using the screw in an end portion of a central portion of the inverted U shaped clamp, the grate can be maintained in a generally horizontal position, at a variably selected height above the fire.

In a preferred aspect of this invention the grate assembly has a grate-post attachment means comprises a screwed hole and tube screw extending through a central portion of the tube carrying the grate, positioned on a tube side portion generally opposite to the grate for accessability, to thereby secure the grate at a preferred height above the fire.

Various other objects, advantages and features of this invention will become apparent to those skilled in the art from the following description in conjunction with the accompanying drawings.

### FIGURES OF THE INVENTION

FIG. 1 is a perspective view of a height adjustable fire pit grate assembly wholly carried by a cylindrical fire pit ring.

FIG. 2 is an enlarged perspective view of a the U shaped clamp shown seated on a top portion of the cylindrical fire pit ring shown in FIG. 1.

FIG. 3 is a perspective view of a screw having a head portion which comprises a 90 degree bend in the shaft of the screw to facilitate finger only tightening.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

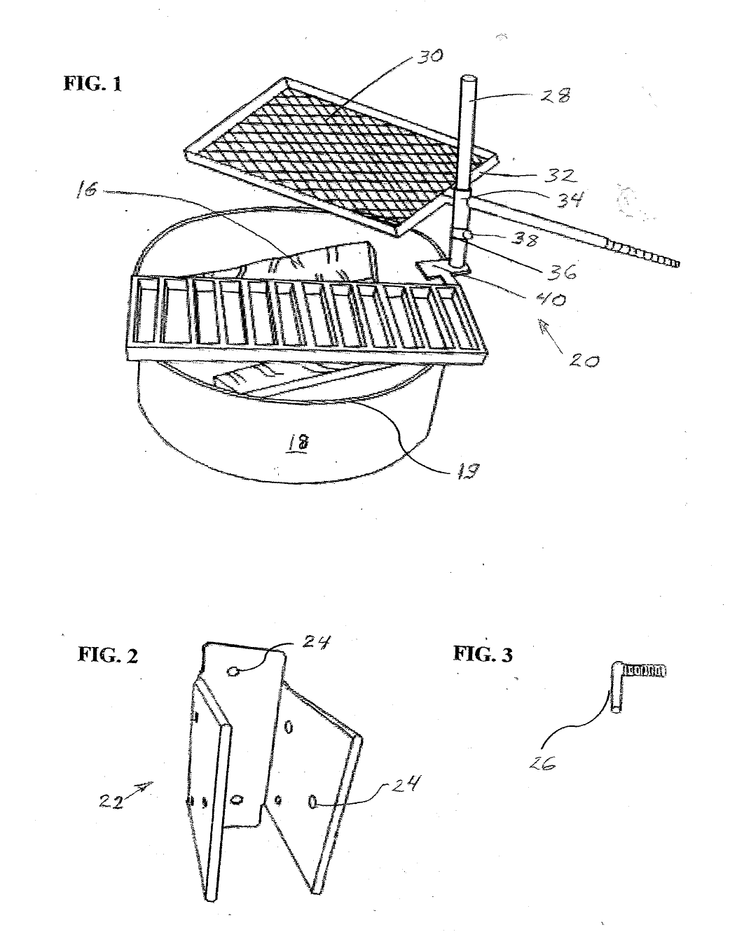

Turning now to the drawings and more particularly to FIG. 1 we have a perspective view of a height adjustable fire pit grate assembly 20 wholly carried by a cylindrical fire pit ring 18. FIG. 2 is an enlarged perspective view of a the U shaped clamp 22 shown seated on a top portion of the cylindrical fire pit ring 18 shown in FIG. 1. Most generally, a height adjustable grate assembly 20 for use over a fire 16, surrounded by a cylindrical fire pit ring 18, comprises: a) an inverted U shaped clamp 22 having an inner and an outer opposite side, said opposite sides generally parallel to each other, and having a central portion extending between, and connecting the two opposite side portions, wherein the outer opposite side portion further comprises a centrally positioned screwed hole 24 and a screw 26 turned therein, to thereby tighten the clamp 22 on the fire pit ring 18, and wherein an end portion of the central portion of the clamp 22 also has a centrally positioned screwed hole and a screw turned therein, to level the clamp 22 when it is seated on the cylindrical fire pit ring 18 if the ring thereunder is not level; b) a post 28 attached to the clamp 22, extending upwardly therefrom; and, c) a grate 30, surrounded by a frame 32, said frame 32 attached to, and carried by a cylindrical tube 34, sized to closely fit over the the post 32, and further comprising grate-post attachment means 36 to clamp the grate 30 to the post 28 at a preferred height. After the inverted U shaped clamp 22 is seated on a top portion of the cylindrical fire pit ring 18, and leveled using the screw 26 in an end portion of a central portion of the inverted U shaped clamp 22, the grate 30 can be maintained in a generally horizontal position, at a variably selected height above the fire 16.

In a preferred aspect of this invention the grate assembly 20 has a grate-post attachment means 36 which comprises a screwed hole 38 and tube screw 26 extending through a central portion of the tube 34 carrying the grate 30, positioned on a tube side portion generally opposite to the grate 30 for accessability, to thereby secure the grate 30 at a preferred height above the fire 16. In one embodiment of the invention the height adjustable grate assembly 20 further comprises a rectangular plate 40 to which the post 28 is first attached and to which in turn is attached to the U shaped clamp 22.

FIG. 3 is a perspective view of a screw 26 having a head portion which comprises a 90 degree bend in the shaft of the screw to facilitate finger only tightening. Most preferably the screws 26 have a head end portion which is adapted to be turned and tightened by fingers, without the use of any tool.

In the most preferred embodiment of the invention the central portion of the clamp 22 has sufficient width to allow the clamp 22 to slide down over a fire pit ring having a top rim 19, and wherein the outer side portion of the clamp 22 has three screwed holes 24 each having a tightening screw 26 therein, and wherein two of the holes 24 are laterally spaced from each other on a top side portion of the outer side of the clamp 22, and wherein the other screwed hole and screw 26 is centrally positioned on a lower side portion of the outer side Of the clamp 22. Most preferably the other inner side portion of the clamp 22 also has three similarly positioned screwed holes 24 and screws 26 therein. Most preferably the central portion of the clamp 22 has two screwed holes 24 and screws 26, each centrally positioned on an opposite end portion of the central portion of the clamp 22.

The inverted U shaped clamp 22 has been fabricated with 3/16″ thick plate steel. The fabricated clamp sized generally 3″×3″×2″ thick, was found to be sufficient in size to firmly hold the height adjustable fire grate wholly on a top portion of the cylindrical ring. The U shaped clamp 22 was fabricated with a thickness of 2″ to accommodate a lip 19 on a top portion of the cylindrical fire pit ring 18.

A general method of using the height adjustable grate assembly comprises the following steps: a) positioning the inverted U shaped clamp 22 on and over a top side portion of the fire pit ring 18; b) leveling the clamp 22 by adjusting the two screws 26 which extend through the central portion of the clamp 22; c) fully tightening all of the screws 26 on the outer side portion and inner side portion of the clamp 26 so that the clamp 22 is tightly held on the fire pit ring 18; d) sliding the tube 34 carrying the grate 30 over the post 28 and moving the grate 30 down to a selected height above the fire 16 and then, e) tightening the tube screw 26 sufficiently to hold and maintain the grate 30 at the selected height above the fire 16. A more particular method specifies that after all of the screws 26 in the side portions of the clamp 22 are first snugged, rechecking the level of the clamp 22 to ensure it has remained level before fully tightening all of the screws 26 in the side portions of the clamp 22.

While the invention has been described with preferred specific embodiments thereof, it will be understood that this description is intended to illustrate and not to limit the scope of the invention, which is defined by the following claims.

1. A height adjustable grate assembly for use over a fire, surrounded by a cylindrical fire pit ring, comprising:
a) an inverted U shaped clamp having an inner and an outer opposite side, said opposite sides generally parallel to each other, and having a central portion extending between, and connecting the two opposite side portions, wherein the outer opposite side portion further comprises a centrally positioned screwed hole and a screw turned therein, to thereby tighten the clamp on the fire pit ring, and wherein an end portion of the central portion also has a centrally positioned screwed hole and a screw turned therein, to level the clamp when it is seated on the cylindrical fire pit ring if the ring thereunder is not level;
b) an upwardly extending post attached to the clamp;
c) a grate, surrounded by a frame, said frame attached to, a cylindrical tube, sized to closely fit over the post, and further comprising grate-post attachment means to clamp the grate to the post at a preferred height;
so that after the inverted U shaped clamp is seated on a top portion of the cylindrical fire pit ring, and leveled using the screw in an end portion of a central portion of the inverted U shaped clamp, the grate can be maintained in a generally horizontal position, at a variably selected height above the fire.

2. A height adjustable grate assembly as in claim 1 wherein the grate-post attachment means comprises a screwed hole and tube screw extending through a central portion of the tube carrying the grate, positioned on a tube side portion generally opposite to the grate for accessability, to thereby secure the grate at a preferred height above the fire.

3. A height adjustable grate assembly as in claim 1 wherein the post is first attached to a generally rectangular plate, which in turn is attached to the U shaped clamp.

4. A height adjustable grate assembly as in claim 2 wherein the screws have a head end portion which is adapted to be turned and tightened by fingers, without the use of any tool.

5. A height adjustable grate assembly as in claim 4 wherein the screws have a head portion which comprises a 90 degree bend in the shaft of the screw to facilitate finger only tightening.

5. A height adjustable grate assembly as in claim 2 wherein the grate further comprises a handle extending from a side of the tube opposite to the grate attached to the other side of the tube.

6. A height adjustable grate assembly as in claim 5 wherein the central portion of the clamp has sufficient width to allow the clamp to slide down over a fire pit rig having a top rim, and wherein the outer side portion of the clamp has three screwed holes each having a tightening screw therein, and wherein two of the holes are laterally spaced from each other on a top side portion of the outer side of the clamp, and wherein the other screwed hole and screw is centrally positioned on a lower side portion of the outer side of the clamp.

7. A height adjustable grate assembly as in claim 6 wherein the other inner side portion of the clamp also has three similarly positioned screwed holes and screws therein.

8. A height adjustable grate assembly as in claim 6 wherein the central portion of the clamp has two screwed holes and screws, each centrally positioned on an opposite end portion of the central portion of the clamp.

9. A height adjustable grate assembly as in claim 8 wherein the clamp is fabricated from 3/16″ thick plate steel.

10. A height adjustable grate assembly as in claim 9 wherein the clamp is generally 3″×3″×2″ thick.

11. A method of using the height adjustable grate assembly as specified in claim 8 comprising the following steps:
a) positioning the inverted U shaped clamp on and over a top side portion of the fire pit ring;
b) leveling the clamp by adjusting the two screws which extend through the central portion of the clamp;
c) fully tightening all of the screws on the outer side portion and inner side portion of the clamp so that the clamp is tightly held on the fire pit ring;
d) sliding the tube attached to the grate over the post and moving the grate down to a selected height above the fire; and then,
e) tightening the tube screw sufficiently to hold and maintain the grate at the selected height above the fire.

12. A method as in claim 11 after all of the screws in the side portions of the clamp are first snugged, then rechecking the level of the clamp to ensure it has remained level; before fully tightening all of the screws in the side portions of the clamp.
